(19) United States
(12) Patent Application Publication
(10) Pub. No.: US 2014/0372154 A1
(43) Pub. Date: Dec. 18, 2014

(54) AUTOMATED TRAVEL TRACKING SYSTEM

(71) Applicant: Voyage Manager Limited, Cambridge (GB)

(72) Inventor: John Christian Scott, Cambridge (GB)

(21) Appl. No.: 13/916,815

(22) Filed: Jun. 13, 2013

(51) Int. Cl. G06Q 10/02

(52) U.S. Cl. CPC G06Q 10/02
USPC 705/5

(57) ABSTRACT

A system for monitoring travel of users is provided. The system includes a computing arrangement coupled via a communication network to communication devices of the users, the computing arrangement being operable to execute software products stored on machine-readable data storage media. The computing arrangement is operable to store travel itineraries of the users, to send messages to the communication devices of users when implementing their travel itineraries and enable the users to respond to the messages by sending corresponding responses from their communication devices such that the corresponding responses are checked by the computing arrangement against the travel itineraries to determine whether there arises a deviation therefrom.

### TECHNOLOGICAL FIELD

The present disclosure generally relates to travel tracking systems, and more specifically, to an automated travel tracking system for monitoring the travel of users. Moreover, the present disclosure also concerns methods of operating such systems for automatically monitoring travel of users. Furthermore, aspects of the disclosure are also directed to software products or computer program code products recorded on machine-readable data storage media, wherein such software products or computer program code products are executable upon computing hardware, to implement the methods of the disclosure.

### BACKGROUND

As people feel that the world has become a smaller place, global travel has become more and more common, and it has become important to know accurate and timely information relating to travelers and valuable assets on the move. With governments imposing increasing amounts of duty of care legislation on companies, there arises a requirement for such companies to implement systems that can provide accurate and current information regarding whereabouts of their employees.

Employees working for organizations that require them to travel to remote locations often complain that the company does not do enough to keep them safe. For organizations, keeping their employees safe is critical for staff retention, recruitment and investment. Moreover, when an event or disaster occurs, of man-made or natural origin, timing is often a critical factor. Being able to accurately locate travelers is critical to the safety of the travelers. Additionally, operational delays due to employees not being present on time can cost organizations thousands or millions of dollars per day. It is thus desirable to try to reduce adverse effects of delays by having accurate and current or real-time information about employee location and movement, thereby potentially saving significant amounts of money for organizations.

Existing travel tracking solutions fall into two categories, itinerary tracking and GPS or location tracking systems. Itinerary tracking systems import and store travel itineraries often used by travel agents and airlines. At any time, the location of a traveler can be determined by referring to these itineraries. However, the itineraries imported from the travel agents and airlines often fail to provide information on the correct location of the user, when there is any change in a travel plan of the traveler during his or her travel.

Location and GPS tracking solutions have been in use for several years now and utilize GPS, cell tower, WIFI networks and Geofences to provide information about the location of a device or a phone. However, none of these known solutions provide automated travel tracking with automated communication possibilities, and real location information of the traveler. Moreover, with many unforeseen events, change of plans, even natural disasters, there is an increased need for a simple and efficient travel tracking solution that allows accurate and timely information relating to travelers or valuable assets on the move.

### SUMMARY

The present disclosure provides a system for monitoring travel of one or more users, and a method for operating the same.

In one aspect, embodiments of the present disclosure provide a system for monitoring travel of users. The system includes a computing arrangement coupled in communication via a communication network to one or more communication devices of the users. The computing arrangement executes sofrwate products or computer program code products stored on machine-readable data storage media to store one or more travel itineraries of the users, and send messages to the communication devices of users when implementing their travel itineraries. When the users respond to the messages by sending corresponding responses from their communication devices the responses are checked by the computing arrangement against the travel itineraries to determine whether there arises a deviation therefrom. The messages, the corresponding responses for the users, or both are implemented by using at least one of: SMS, MMS, Instant messaging (IM), social media, spread sheets, e-mails, voice.

The travel itineraries are imported from at least one of: booking engines GDSs, third-party itinerary systems, Triplt, WorldMate API, SMS (text message), e-mail and may include flight, train, hotel, car rental and other transport itineraries of the travelers.

The computing arrangement is operable to update automatically the travel itineraries in an event of delays in travel for the users being informed to the computing arrangement. One or more Short Message Service (SMS) are sent to the computing arrangement for updating the travel itineraries corresponding to the mobile phone number.

The computing arrangement is operable to generate alerts when the deviation of the one or more travel itineraries exceeds one or more alarm thresholds. Alerts are generated in form of SMS, voice, e-mail, or any other electronic communication when a user sends an SOS or fails to confirm successful departure, arrival, or other event like changed travel.

The computer arrangement is operable to track geographical locations of the communication devices by employing GPS, GPS equivalent systems like GLONASS, mobile telephone network cell tower location, WIFI networks, HLR. The location tracking using HLR function is useful, when the user is not able to send a confirmation response due to weak mobile phone signals, roaming charges for sending or receiving messages are very high or both of these. Moreover, the location of the user can be tracked down to a few meters, when their communication device is equipped with GPS functionality.

In another aspect, the computer arrangement is operable to send one or more messages to the one or more users when travelling regarding rendezvous with one or more other individuals. The one or more messages may include contact details and photo of the one or more other individuals.

In yet another aspect, the computer arrangement is operable to log a period in which a given user is present in one or more countries. The number of days and hours a user has spent in a country may be logged to send alerts to the user regarding any issues that could affect the legal implications for tax or immigration.

In yet another aspect, the computer arrangement is operable to compute one or more Carbon Dioxide emissions footprint for the one or more users when implementing their one or more travel itineraries, wherein the footprint is at least partially determined by a mode of transport employed by the one or more users.

In yet another aspect, embodiments of the present disclosure provide a method of using the system for monitoring travel of one or more users.

In an alternative embodiment of the present disclosure a system for monitoring travel of one or more users, wherein the system includes a computing arrangement coupled in communication via a communication network to one or more communication devices of the one or more users, wherein the computing arrangement is operable to execute one or more sofrwate products or computer program code products stored on machine-readable data storage media, wherein the computing arrangement is operable to store one or more travel itineraries of the one or more users, and to receive one or more messages from communication devices, which have a tracking device function, of one or more users when implementing their one or more travel itineraries, such that the one or more users communication devices automatically update location and status of the one or more users, and such that the one or more corresponding responses are checked by the computing arrangement against the one or more travel itineraries to determine whether there arises a deviation therefrom.

This allows for the one or more users to automatically travel around without interacting with the system and hence decreases the feeling of being tracked for any other reason than for their own well being. Further it allows for good control of the communications so that low bandwidth, off peak and best mode of operation e.g. cellular or operator network rather than satellite network being used when the tracking device has intelligence to select the preferred option.

Embodiments of the present disclosure provide a system that provides automated travel tracking with automated communication possibilities, and real location information of the traveler. The travel tracking system combines the itinerary information sources, communication systems, flight information systems, mobile network data, smart phones and GPS trackers to provide accurate and timely information relating to travelers or valuable assets on the move. The travel tracking system monitors the departure and arrival of the traveler for each leg of a trip, thus ensuring that the traveler is following the itinerary and notifying relevant parties throughout the trip.

Additional aspects, advantages, features and objects of the present disclosure would be made apparent from the drawings and the detailed description of the illustrative embodiments construed in conjunction with the appended claims that follow.

It will be appreciated that features of the invention are susceptible to being combined in various combinations without departing from the scope of the invention as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the invention is not limited to specific methods and instrumentalities disclosed herein. Moreover, those in the art will understand that the drawings are not to scale. Wherever possible, like elements have been indicated by identical numbers.

FIG. 1 is an illustration of a high level architecture of a system for monitoring travel of users, that is suitable for practicing various implementations of the present disclosure;

FIG. 2 is an illustration of a travel tracking system of FIG. 1, in accordance with the present disclosure;

FIG. 3 is an illustration of various events related to travel of a user, in accordance with the present disclosure;

FIG. 4 is an illustration of steps of a method of importing new travel itineraries into a database, in accordance with the present disclosure;

FIG. 5 is an illustration of steps of a method of updating travel itinerary by a user, in accordance with the present disclosure;

FIG. 6 is an illustration of steps of a method of monitoring travel of a user, in accordance with the present disclosure; and

FIG. 7 is an illustration of steps of a method of using the system of FIG. 2 for monitoring travel of a user, in accordance with the present disclosure.

### DETAILED DESCRIPTION OF ILLUSTRATIVE EMBODIMENTS

The following detailed description illustrates embodiments of the disclosure and ways in which it can be implemented. Although the best mode of carrying out the invention has been disclosed, those in the art would recognize that other embodiments for carrying out or practicing the invention are also possible.

The present disclosure provides a system and method for monitoring travel of one or more users, which users may be people, pets or valuable assets. The system includes a computing arrangement coupled in communication via a communication network to one or more communication devices of the users. The computing arrangement is operable to execute sofrwate products or computer program code products stored on machine-readable data storage media and store travel itineraries of the users. The travel itineraries are imported from at least one of: booking engines GDSs, third-party itinerary systems, Triplt, WorldMate API, and are updated automatically in an event of delays in travel for the users. The computing arrangement is further operable to send messages to the communication devices of users when implementing their travel itineraries, such that the users respond to the messages by sending corresponding responses from their communication devices. The messages corresponding responses or both are implemented by using at least one of: SMS, MMS, IM, social media, web, spread sheets, e-mails, voice. The corresponding responses are checked by the computing arrangement against the travel itineraries to determine whether there arises a deviation therefrom. One or more alerts are generated when the deviation of the one or more travel itineraries exceeds one or more alarm thresholds. Certain types of messages, for example SMS, employ negligible communication system bandwidth and are therefore especially economical to employ when verifying whether a given user is following a prearranged itinerary. The messages may also be alerts showing positive information of accurate location, time and status of the one or more users.

The computing arrangement is further operable to track geographical locations of the communication devices by employing GPS, mobile telephone network cell tower location, WIFI networks and HLR, to send messages to the users when travelling regarding rendezvous with other individuals, to log a period in which a given user is present in one or more countries, and to compute Carbon Dioxide emissions footprint for the user when implementing their travel itineraries, wherein the footprint is at least partially determined by a mode of transport and type of transport vehicle or vessel employed by the users. There are also embodiments where the type of travel goes down to the level of vehicle operation and even the type of fuel in a Hybrid vehicle. Then the geo-fencing can be used to trigger the change from one mode of operation to the other in the vehicle or e.g. report the type of tax associated with the users travel.

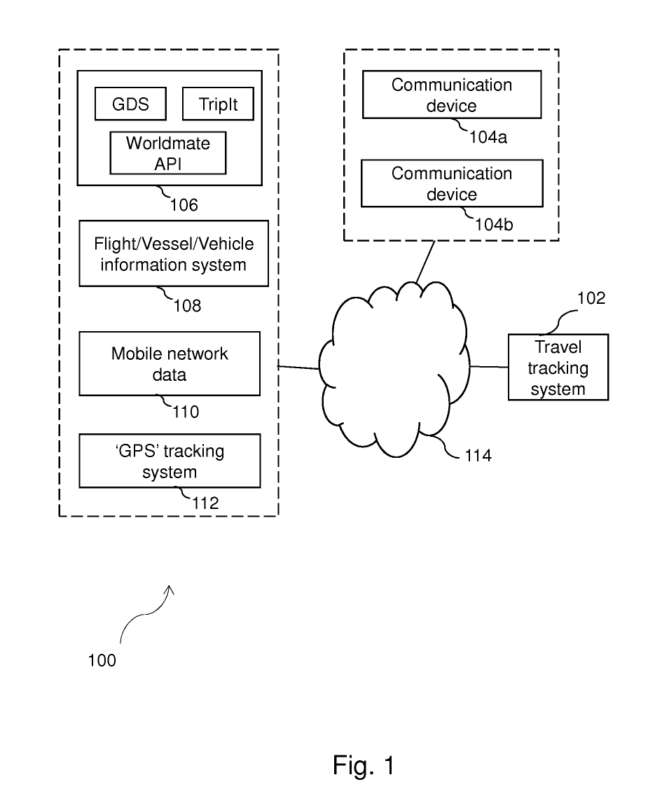

Referring now to the drawings, particularly by their reference numbers, FIG. 1 is an illustration of a high level architecture of a system 100 for monitoring travel of one or more users. The system 100 includes a travel tracking system 102 coupled in communication with communication devices 104a and 104b (hereinafter collectively referred to as communication devices 104) and Itinerary information system 106, flight information system 108, mobile network data system 110, and GPS tracking system 112, by way of a communication network 114. Examples of the communication network 114 include, but are not limited to, telecommunication network, mobile network, and Internet. Also the number of users and communication devices 104 can be from tens up to several hundred thousand running on the same system 100. The communication devices 104 include but are not limited to tracking devices, cellular phones, smartphones, tablet computers, phablets or other suitable portable device.

The travel tracking system 102 incorporates a computing arrangement including computing hardware operable to execute one or more non-transitory software products or computer program code products stored on machine-readable data storage media. Storage media include but are not limited to hard drives, DVDs, CDs, memory sticks, memory cards, servers, cloud based storage, or other suitable media. In an embodiment, the travel tracking system 102 incorporates a server system, that can be arranged as cloud service or as dedicated servers located in single or distributed sites. The communication devices 104, for example mobile phones, smartphones, PCs, laptops, tablets or phablets, can be carried by one or more users (hereinafter referred to as travelers) of the travel tracking system 102.

Itinerary information system 106 provides information regarding flight, train, hotel and other transport itineraries of one or more travelers. Itinerary information system 106 may include Global Distribution Systems (GDSs) such as Amadeus, Galileo, and Sabre, and 3^{rd} party itinerary systems such as TripIt and WorldMate API. Flight information system 108 provides updates on where one or more flights are in real time. Mobile network data system 110 provides for geographical location of the mobile communication devices 104 by employing one or more of mobile telephone network cell tower location, WIFI networks and Home location record (HLR). The GPS tracking system 112 provides geographical location of the mobile communication devices 104 based on the GPS tracking.

The communication device 104 constantly, or periodically, communicates with the travel tracking system 102, which, in turn, communicates with the itinerary information system 106, flight information system 108, mobile network data system 110 and the GPS tracking system 112 to receive travel and location information of the travelers, and process the received information to generate substantially real time location information of the travelers. In an embodiment of the present invention, the communication devices 104 may communicate with the travel tracking system 102, or the travel tracking system 102 may communicate with communication devices 104, by way of voice, email, SMS, or MMS. In another embodiment of the present invention, the travel tracking system 102 may provide a graphical display on the communication devices 104 to enable users to communicate and navigate through the travel tracking system 102. While communication is generally from the communication devices 104 to the system 100 in some circumstances, e.g. an emergency situation, the system 100 communicates back to the users.

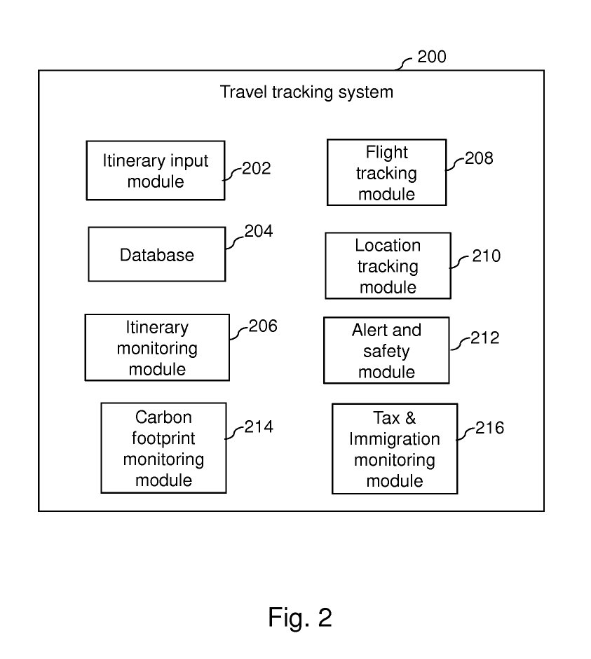

FIG. 2 is an illustration of a travel tracking system 200, which is an example of the travel tracking system 102, in accordance with the present disclosure. The travel tracking system 200 includes an itinerary input module 202, a database 204, an itinerary monitoring module 206, a flight tracking module 208, a location tracking module 210, a safety and alert module 212, a Carbon footprint monitoring module 214, or a Tax and immigration module 216.

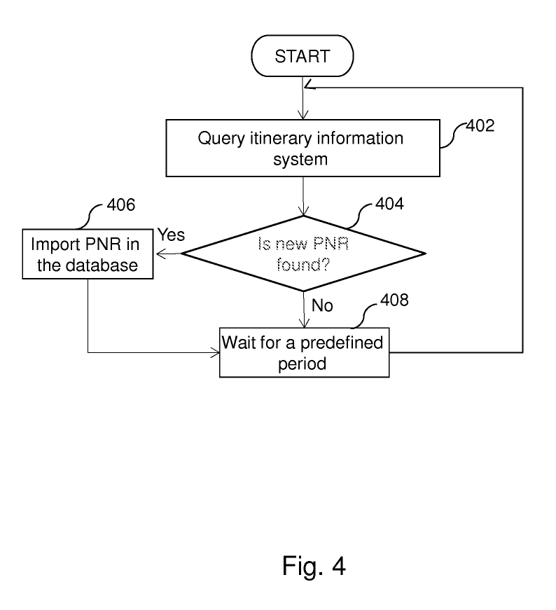

The itinerary input module 202 is configured to import flight, train, hotel, car rental and other transport itineraries of the travelers from the itinerary information system 106 and store them in the database 204. In an embodiment of the present disclosure, the itinerary input module 202 polls the GDSs or booking engines of the itinerary information system 106 at pre-defined intervals and retrieves any new PNRs (travel itineraries) corresponding to the travelers. Optionally the GDS may also push data to the itinerary information system 106 or any other part of the system 100 that use the data. The pushed GDS data may also be deposited in a directory or server and picked up by the system 100 when needed or at scheduled times to, for example, optimize the data transfer during low usage of the communication networks or off peak data transfer periods. In another embodiment, the itinerary input module 202 imports itinerary information of a traveler from one or more 3^{rd} party itinerary systems such as TripIt or WorldMate API. In an example, a TripIt account of the traveler may be linked to the travel tracking system 200, and the itinerary input module 202 may poll the TripIt account at pre-defined intervals, and automatically imports a new booking/itinerary of the traveler into the database 204. In another example, a traveler may forward their travel itinerary of WorldMate API to an email address specified by the itinerary input module 202 to automatically import their travel itinerary in the database 204. There are also updates of the data in the database 204, which are automatically amended, deleted or modified to keep the information up to date based on the input data to the system 100. The steps of the method of importing a travel itinerary of a traveler from the itinerary information system 106 are explained below with reference to FIG. 4.

In yet another embodiment, the travelers may update their travel itinerary in the database 204 through their communication devices 104. In an example, a traveler may send one or more Short Message Service (SMS) messages to the system 200 to update their travel itineraries corresponding to their mobile number. The SMS may include codes like, for example,

FLIGHT NEW [AIRLINE CODE] [FLIGHT NUMBER]
FLIGHT NEW [AIRLINE CODE] [FLIGHT NUMBER] [DATE]
FLIGHT CANCEL [AIRLINE CODE] [FLIGHT NUMBER]
FLIGHT CANCEL [AIRLINE CODE] [FLIGHT NUMBER] [DATE]

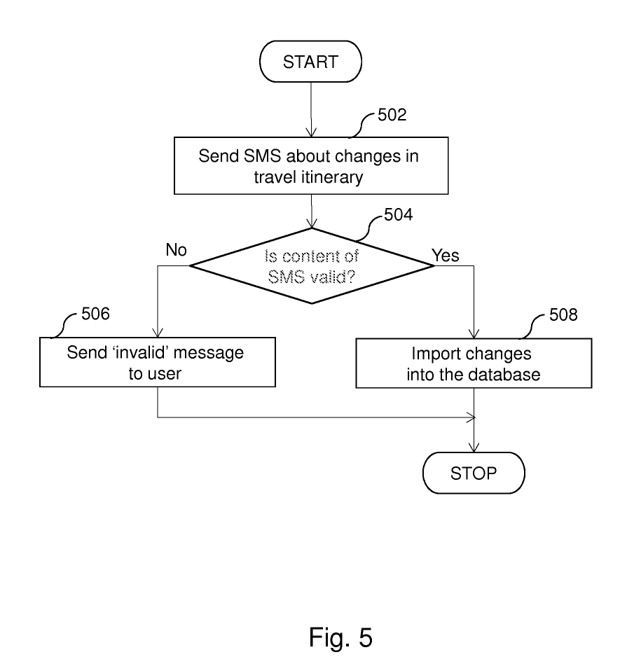

The steps of the method of updating the travel itineraries by the traveler by SMS are explained below with reference to FIG. 5. In another example, the traveler may update their travel itineraries in the database 204 through the graphical display executing on their communication device 104. In yet another embodiment, the travel itineraries of the travelers may be entered manually into the database 204 by a travel operator or traveler.

The itinerary monitoring module 206 is linked to the database 204, and monitors the traveler's itineraries (hereinafter referred to as trips) stored in the database 204. The itinerary monitoring module 206 monitors the progress of a trip from the moment the trip has been entered into the database 204 until after the trip has been completed to identify where the traveler is at any given time. In an example, the itinerary monitoring module 206 loads the active trips from the database 204 every 60 seconds and performs checks on the trips. Alternatively, the itinerary monitoring module 206 can be scheduled to check at any pre determined time whether any action is needed on an itinerary for example at 2 minute intervals. Alternatively event data can be input into a scheduler and only processed when an itinerary is queried or when the scheduler determines it should be done. The itinerary monitoring module 206 confirms the departure and arrival of the traveler for each leg of a trip, thus ensuring that the traveler is following the itinerary and notifying relevant parties throughout the trip. Examples of the relevant parties include, but are not limited to, family members and friends of the traveler, security company, organization of which the traveler is an employee, and the like. The itinerary monitoring module 206 can immediately alert the relevant parties by SMS, voice, e-mail, or any other electronic communication when a traveler sends an SOS or fails to confirm successful departure or arrival, or when the itinerary monitoring module 206 registers a deviation from the itinerary or for positive events such as safe arrival or similar.

In an example, prior to a trip segment starting, the itinerary monitoring module 206 asks a traveler to confirm their departure, by SMS, Email, voice or a combination of these. Based on the traveler's feedback, the itinerary monitoring module 206 automatically updates the trip status in the database 204. Examples of the trip status include, but are not limited to, Not started′, ‘In progress’, ‘Pending arrival’, and ‘Arrived’. The process of querying a traveler prior to a trip segment starting enables identifying the location of the traveler, when their communication devices 104 are not in coverage area, (e.g. the traveler is on a flight requiring their mobile phones 104 be switched off) until the mobile device 104 is in communication again. The itinerary monitoring module 206 may further ask the traveler to confirm his or her arrival by way of SMS, email, voice or a combination of these when they have arrived or upon de-boarding the flight.

The flight tracking module 208 is linked to the database 204 and the itinerary monitoring module 206, and keeps a track on departure and arrival of traveler flights based on information received from the flight information system 108. In an embodiment, the flight tracking module 208 may confirm a traveler's arrival at their destination airport, based on an arrival of the corresponding flight, and automatically updates the status of the traveler in the database 204, without interacting with the traveler. The flight tracking module 208 may also automatically update any changes in flight schedules of one or more travelers in the database 204. Although, the flight tracking module 208 has been disclosed for tracking flights, the travel tracking system 200 may include modules for tracking location of any of a variety of transportation means including but not limited to trains, boats or automobiles.

The location tracking module 210 is linked to the database 204, the itinerary monitoring module 206 and the flight tracking module 208, and tracks the real-time location of a traveler using his or her mobile phone signals, smartphone and GPS tracking device. The location tracking module 210 combines, mobile operator network data (HLR), geo-fencing and geo-routing features to detect the current country or region of a communication device 104 of the traveler, and provide automatic notifications to the traveler and the relevant parties, when the traveler departs, enters or stays within specified areas, or when he or she deviates from his or her designated routes. In an example, the location tracking module 210 may determine the country location of a mobile communication device 104 using the HLR, in which the location tracking module 210 may query the cell tower operators to check whether a specific mobile device 104 has been switched on, on arrival in a country. If the mobile device 104 has been switched on, the location tracking module 210 determines that the traveler is in the country, and may automatically update the status and location of the traveler in the database 204.

Thus, automated confirmation using HLR function allows a % feedback loop confirmation by travelers to increase to >96%. In an example, when a given traveler does not notify his or her arrival or location to the itinerary monitoring module 206, then the location tracking module 210 checks with the HLR (cell tower in the Cellular network) whether or not a mobile device 104 has been turned on, and then updates the itinerary in the database 204 that the traveler has arrived in the country, city or other location, to make sure that an automated feedback loop takes place when the traveler does not notify their arrival or location via a confirmation message. Automated confirmation using HLR function is useful in instances, when the traveler is not able to send a confirmation message due to weak mobile phone signals, when very high roaming charges for sending and receiving messages, the user is lazy or any combination of these. The automated confirmation of location using HLR function further reduces the transfer of messages between the itinerary monitoring module 206 and the communication device 104. The location tracking module 210 further triggers an alarm and automatically issues emails, SMS or automated calls to a set of relevant parties a predefined time period after determining, based on the HLR information, that the corresponding mobile device 104 has not been switched on.

When the traveler has a communication device 104 with GPS functionality or other tracking technology, location tracking module 210 may further track the exact location of the traveler within a few metres. The communication device 104 with GPS functionality provides automated updates of traveler location (e.g. every 5 min, 15 min, 1 hour, 2 hours or daily depending upon what is optimum for the situation, the battery life of the device 104, or both) via GPS (GSM) network, satellite or both. For a given traveler having a communication device 104 with GPS functionality, the location tracking module 210 may dynamically apply a Geo-fence around a departure and arrival location of the given traveler at respective departure and arrival times. The size of the Geo-fence may be dynamically configured based on the mode of travel to assist with accurate arrival information. For example, around airports and flights, the size of the Geo-fence may be in the range of 1000 metres to 15000 metres. While taking a taxi to the hotel, a smaller Geo-fence of size ranging from 50 metres to 100 metres is sufficient.

The alert and safety module 212 is linked to the database 204, monitoring module 206, flight tracking module 208, and the location tracking module 210, and provides extra safety measures for travelers traveling in high-risk locations such as those prone to terrorist attacks, natural calamities, wars or the like. In an embodiment, the alert and safety module 212 sends automated check-in requests to the travelers when a threat level in a location is above a specified threshold on any trip or in certain countries where a higher alert level is needed as preset or adjustable during a trip. When a given traveler fails to reply to the automated check-in requests, then the alert and safety module 212 may immediately alert the relevant parties and security personnel in that location by SMS, e-mail or voice. In another embodiment, the relevant parties and the security personnel may monitor the status of travelers through the graphical display of the travel tracking system 200 executing on their communication devices 104. Due to privacy issues there may be an escalation procedure where an administrator of the system 100 is able to get authorization to find the exact location of the user(s) in the event of an emergency. Otherwise the system may be set to track users only during working hours, only give rough indication of location in a given city, if they leave a certain geo-fenced area, or needed to be evacuated due to natural disaster or terrorist attack.

The alert and safety module 212 further provides a ‘meet and greet’ facility to travelers when they are travelling in the high-risk locations. Based on the arrival information of travelers in the database 204, drivers and security personnel may be provided for picking up the travelers from corresponding airports and other locations. Prior to pick up, the alert and safety module 212 may send the contact details, a photo of the person the traveler is going to meet or both, allowing the traveler to determine that they are meeting with the right person. The alert and safety module 212 may link the ‘meet and greet’ feature to ‘Geo-fencing’ feature to monitor the location of the travelers escorted by the security personnel. The linking of ‘meet and greet’ and ‘Geo-fencing’ features is useful in monitoring the safety of High Net Worth Individuals (HNWI).

The alert and safety module 212 may further group certain travelers travelling to a joint destination such as an oil rig or boat, but originating from a same location or different locations by same or different modes of travel. The alert and safety module 212 may further link the location updates and travelers' messages regarding their locations to social media such as Twitter, Facebook or other forum; “Twitter” and “Facebook” are registered trademarks.

The alert and safety module 212 may be further linked to government bodies and security companies of a country or region for automatically notifying the travelers and the relevant parties regarding the latest travel and security information for the respective country or region, by way of automatic alert feeds. The alert and safety module 212 may further log the number of days and hours, a traveler has spent in a country and send alerts to the traveler and relevant parties regarding any issues that could affect the legal implications for tax or immigration.

The Carbon footprint monitoring module 214 may compute Carbon Dioxide emissions footprint for the travelers based on their mode of transport, travel time, travel location stored in the database 204. This can then be linked to the tax paid by the user's employer when it comes to their carbon footprint as carbon taxes in certain countries or jurisdictions become a reality. The Carbon footprint monitoring module 214 may trigger messages to the users or those coordinating the users when someone is getting close to a certain threshold or limit, allowing a less carbon emitting mode of transport to be taken.

The Tax and Immigration monitoring module 216 monitors the time (weeks, days, hours) a user spends in any given country or jurisdiction allowing alerts or information to be sent to the user or those coordinating the user's travel to avoid tax bills if someone overstays or spends too much time in the place. This has large implications for corporations who often have multimillion dollar tax bills if employees become taxable in a country or jurisdiction. It is a similar issue with the immigration monitoring as Visas, when someone is about to become get residence, are important matters and could affect the ability for a company to operate in a country if rules and regulations are not respected. The Tax and Immigration monitoring module 216 runs checks taking into account e.g. combining hard coded date location information with itinerary, HLR and GPS data to give the best possible overview and show the user's situation. The analysis takes into consideration whether travel is in transit, what type of project or work is being done, if on holiday or on business etc to make sure the traveler is compliant with any tax and immigration rules. The analysis may also be used as a proof of compliance with rules and regulations and to show a Duty of Care is being taken on behalf of the user.

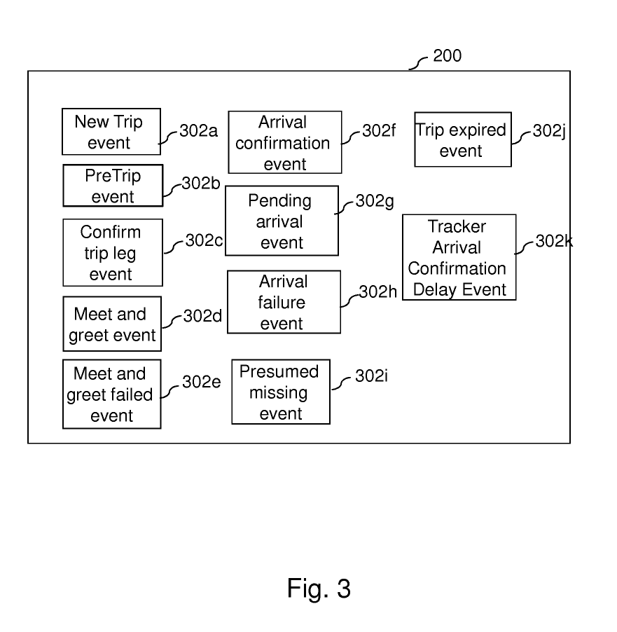

FIG. 3 is an illustration of a first progression through eleven events 302a to 302j (hereinafter collectively referred to as events 302) in the travel tracking system 200, in accordance with the present disclosure. The travel tracking system 200 performs actions through the events 302. An event 302 is created by the system 200, a traveler or a relevant party, and is activated by the system 200, when required. The events 302 may be activated by their respective triggers, and the actions corresponding to the events 302 may be executed by at least one of the itinerary input module 202, the itinerary monitoring module 206, the flight tracking module 208, the location tracking module 210, the safety and alert module 212, and the Carbon footprint monitoring module 214. Although, eleven events 302 are shown, it will be apparent to those skilled in the art, the system 200 may include more or less than eleven events 302. For example, some events may be combined into a single event, divided into multiple events or eliminated.

A new trip event 302a is activated, when a new trip is added to the database 204. In the new trip event 302a, the system 200 may send a notification regarding information about the new trip to a communication device 104 of the traveler through email, SMS, other media, voice or a combination of these.

A pre-trip event 302b is activated prior to starting a trip, or before departure of a traveler on his or her trip. In the pre-trip event 302b, the system 200 may send a request to a user to send a confirmation regarding his or her departure on the trip.

A confirm trip leg event 302c is activated to enable the system 200 to confirm whether or not a portion of the trip will occur. The system 200 may do this by sending requests to travelers for their feedback.

A meet and greet event 302d is activated to enable the system 200 to initiate a meet and greet activity for a given traveler upon his or her arrival. A meet and greet failed event 302e is activated when a traveler fails to meet and greet a contact upon arrival within a pre-specified time.

An arrival confirmation event 302f is activated when a traveler arrives at his or her destination. A pending arrival event 302f is activated at the same time. An arrival failure event 302h is activated when a traveler does not arrive at his or her destination within a predefined time period after the trip has changed status to ‘Pending Arrival’. A presumed missing event 302i is activated when a traveler does not arrive at his or her destination within the predefined time period after the trip has changed status to ‘Pending Arrival’ and is required. A trip expired event 302j is activated when a trip of a traveler has expired.

A tracker arrival confirmation delay trigger 302k is activated when a traveler carrying a communication device 104 in the form of a location tracking device opts to delay the arrival confirmation event 302f. If the user has a tracking devise 104 the arrival event may be delayed to allow the tracking device 104 to update the system. The tracking device 104 sends an automated signal at given intervals, often set to conserve battery life or depending on the mode of travel, allowing low level of interaction from the user. This means a fully automated system of travel tracking is implemented. The tracking devices normally have an emergency button allowing the user to trigger relevant events in the case of an emergency. When a smartphone or similar is used as the communication device a software application, also called mobile application, may be used for the tracking via HLR and other modes plus may also include an emergency feature where the user may press an alarm button on the smartphone 104 when needed.

FIG. 4 is an illustration of steps of a method of importing a travel itinerary into the database 204 from the itinerary information system 106, in accordance with the present disclosure. Itinerary information system 106 has been elucidated in conjunction with FIGS. 1 and 2. The method is depicted as a collection of steps in a logical flow diagram, which represents a sequence of steps that can be implemented in hardware, software, or a combination thereof.

At a step 402, the itinerary information system 106 is queried by the itinerary input module 202. At a step 404, it is checked, whether a PNR corresponding to a new itinerary of a traveler is found, updated or cancelled. If a new PNR is found, then at a step 406, the new PNR of the traveler is imported in the database 204, and saved therein. Then, at a step 408, the itinerary input module 202 waits for a predefined time period, and executes steps 402 to 404. When the new PNR is not found, then also, the itinerary input module 202 waits for the predefined time period at the step 408, and executes the steps 402 to 404.

It should be noted here that the steps 402 to 408 are only illustrative and other alternatives can also be provided where one or more steps are added, one or more steps are removed, or one or more steps are provided in a different sequence without departing from the scope of the claims herein.

In another embodiment the user may send an SMS via the communication device 104 to cancel or update any travel plans. This is a very efficient and useful way of activating the system 100 if the user has not been updating the system prior to the departure or arrival at the airport for example.

FIG. 5 is an illustration of steps of a method of updating the travel information in the database 204 by a traveler e.g. via a portable communication device 104, in accordance with the present disclosure. Database 204 and portable communication device 104 have been described in the foregoing with reference to FIGS. 1 and 2. The method is depicted as a collection of steps in a logical flow diagram, which represents a sequence of steps that can be implemented in hardware, software, or a combination thereof.

At a step 502, a traveler sends an SMS to the itinerary input module 202 regarding changes in his or her travel itinerary. At a step 504, it is checked, whether contents of the SMS are valid. If the contents of the SMS are invalid, then at a step 506, an ‘invalid’ message is sent to the traveler. If the contents of SMS are valid, then at a step 508, the changes to the itinerary are imported into the database 204.

It should be noted here that the steps 502 to 508 are only illustrative and other alternatives can also be provided where one or more steps are added, one or more steps are removed, or one or more steps are provided in a different sequence without departing from the scope of the claims herein.

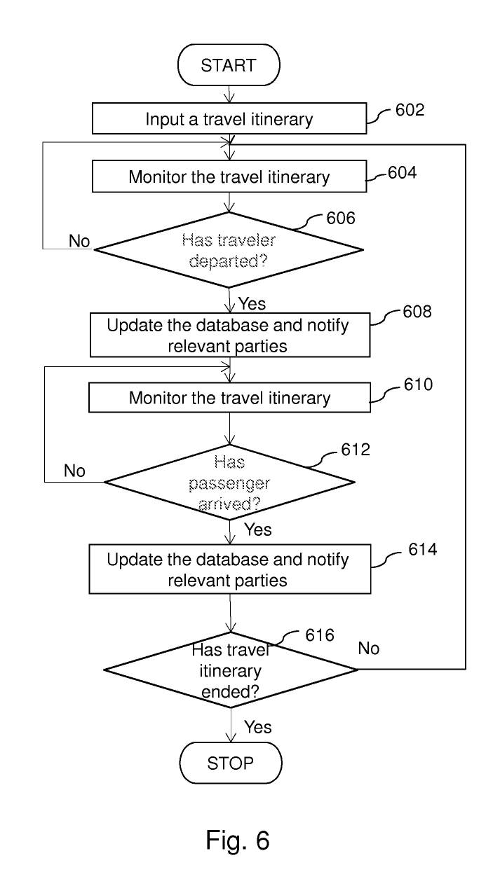

FIG. 6 is an illustration of steps of monitoring the travel of users using the travel tracking system 200, in accordance with the present disclosure, and has been explained in conjunction with FIGS. 1 and 2. The method is depicted as a collection of steps in a logical flow diagram, which represents a sequence of steps that can be implemented in hardware, software, or a combination thereof.

At a step 602, a travel itinerary of a traveler is inputted into the database 204. At a step 604, the travel itinerary is monitored. At a step 606, it is checked whether the traveler has departed from his or her location. If the traveler has departed, then at a step 608, the database 204 is updated and the relevant parties are notified by way of email, SMS, automated calling system, other electronic media or a combination of these. At a step 610, the travel itinerary is again monitored. At a step 612, it is checked whether the traveler has arrived at his or her destination. If the traveler has arrived at his or her destination, then at a step 614, the database 204 is updated and the relevant parties are notified. At a step 616, it is checked whether the travel itinerary has ended. If the travel itinerary has ended, the method ends The steps 602-616 are repeated when the travel itinerary has not ended.

It should be noted here that the steps 602 to 616 are only illustrative and other alternatives can also be provided where one or more steps are added, one or more steps are removed, or one or more steps are provided in a different sequence without departing from the scope of the claims herein.

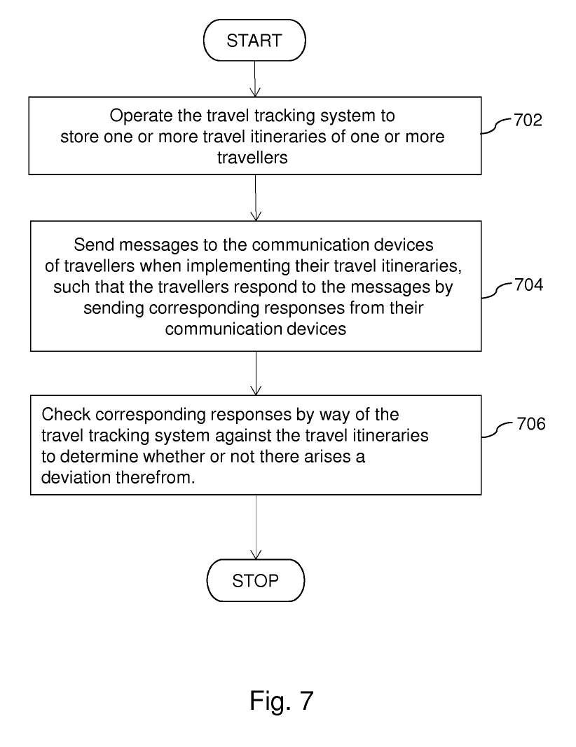

FIG. 7 is an illustration of steps of a method of using the system 200 for monitoring the travel of one or more users, in accordance with the present disclosure, System 200 has been explained in conjunction with FIGS. 1 and 2. The method is depicted as a collection of steps in a logical flow diagram, which represents a sequence of steps that can be implemented in hardware, software, or a combination thereof.

At a step 702, the travel tracking system 200 is operated to store one or more travel itineraries of the one or more travelers in the database 204. The travel itineraries are imported from at least one of: booking engines GDSs, third-party itinerary systems, Triplt, WorldMate API, and are updated automatically in an event of delays in travel for the travelers. At a step 704, one or more messages are sent to the communication devices 104 of the one or more travelers when implementing their travel itineraries and the one or more messaged travelers can respond to the one or more messages by sending one or more corresponding responses from their communication devices 104. The messages, corresponding responses or both are implemented by using at least one of: SMS, spread sheets, e-mails, voice. At a step 706, the corresponding responses are checked by way of the travel tracking system 200 against the travel itineraries stored in the database 204 to determine whether there arises a deviation from the travel itineraries. One or more alerts are generated when the deviation of the one or more travel itineraries exceeds one or more alarm thresholds.

It should be noted here that the steps 702 to 706 are only illustrative and other alternatives can also be provided where one or more steps are added, one or more steps are removed, or one or more steps are provided in a different sequence without departing from the scope of the claims herein.

Although embodiments of the current invention have been described comprehensively, in considerable detail to cover the possible aspects, those skilled in the art would recognize that other versions of the invention are also possible.

What is claimed is:

1. A system for monitoring travel of one or more users, comprising:
a computing arrangement coupled via a communication network to one or more communication devices of the one or more users, wherein the computing arrangement is operable to execute one or more software products stored on machine-readable data storage media, wherein the computing arrangement is operable to store one or more travel itineraries of the one or more users, and to send one or more messages to the one or more communication devices of one or more users when implementing their one or more travel itineraries, such that the one or more users respond to the one or more messages by sending one or more corresponding responses from their one or more communication devices, and such that the one or more corresponding responses are checked by the computing arrangement against the one or more travel itineraries to determine whether there arises a deviation therefrom.

2. The system as claimed in claim 1, wherein the one or more messages, the one or more corresponding responses for the one or more users, or both are implemented by using at least one of: SMS, MMS, IM, social media, spread sheets, e-mails and voice.

3. The system as claimed in claim 1, wherein the computer arrangement is operable to track geographical locations of the one or more communication devices by employing at least one of: GPS, mobile telephone network cell tower location, WIFI networks, and HLR.

4. The system as claimed in claim 1, wherein the one or more travel itineraries are imported from at least one of: booking engines GDSs, third-party itinerary systems, Triplt, WorldMate API, e-mail and SMS.

5. The system as claimed in claim 1, wherein the computer arrangement is operable to automatically update, to the computing arrangement, the one or more travel itineraries in an event of one or more delays in travel for the one or more users being messaged.

6. The system as claimed in claim 1, wherein the computer arrangement is operable to send, to the one or more users, one or more messages regarding rendezvous with one or more other individuals.

7. The system as claimed in claim 1, wherein the computer arrangement is operable to log a period in which one of the one or more users is present in one or more countries.

8. The system as claimed in claim 1, wherein the computer arrangement is operable to compute one or more Carbon Dioxide emissions footprints for the one or more users when implementing their one or more travel itineraries, the footprint being at least partially determined by a mode of transport employed by the one or more users.

9. The system as claimed in claim 1, wherein the computing hardware is operable to generate one or more alerts when the deviation of the one or more travel itineraries exceeds one or more alarm thresholds.

10. A system for monitoring travel of one or more users, comprising:
a computing arrangement coupled via a communication network to one or more communication devices of the one or more users, the communication devices having a tracking device function, wherein the computing arrangement is operable to execute one or more software products stored on machine-readable data storage media, wherein the computing arrangement is operable to store one or more travel itineraries of the one or more users, and to receive one or more messages from communication devices of one or more users when implementing their one or more travel itineraries, such that the one or more users communication devices automatically update location and status of the one or more users, and such that the location and status are checked by the computing arrangement against the one or more travel itineraries to determine whether there arises a deviation therefrom.

11. A method of using a system for monitoring travel of one or more users, the system including a computing arrangement coupled in communication via a communication network to one or more communication devices of the one or more users, and being operable to execute one or more software products stored on machine-readable data storage media, wherein the method comprises:
(a) operating the computing arrangement to store one or more travel itineraries of the one or more users;
(b) sending one or more messages to the one or more communication devices of one or more users when implementing their one or more travel itineraries;
(c) sending one or more corresponding responses from the one or more communication devices of the one or more users to respond to the one or more messages; and
(d) operating the computing arrangement to check the one or more corresponding responses against the one or more travel itineraries to determine whether there arises a deviation therefrom.

12. The method as claimed in claim 11, wherein the method includes implementing the one or more messages, the one or more corresponding responses for the one or more users, or both by using at least one of: SMS, MMS, IM, social media, web, spread sheets, e-mails, voice.

13. The method as claimed in claim 11, wherein the method includes operating the computer arrangement to track geographical locations of the one or more communication devices by employing at least one of: GPS, mobile telephone network cell tower location, WIFI networks and HLR.

14. The method as claimed in claim 11, wherein the method includes importing the one or more travel itineraries from at least one of: booking engines GDSs, third-party itinerary systems, Triplt and WorldMate API.

15. The method as claimed in claim 11, wherein the method includes operating the computer arrangement to automatically update, to the computing arrangement, the one or more travel itineraries in an event of one or more delays in travel for the one or more users being messaged.

16. The method as claimed in claim 11, wherein the method includes operating the computer arrangement to send, to the one or more users, one or more messages regarding rendezvous with one or more other individuals.

17. The method as claimed in claim 11, wherein the method includes operating the computer arrangement to log a period in which one of the one or more users is present in one or more countries.

18. The method as claimed in claim 11, wherein the method includes operating the computer arrangement to compute one or more Carbon Dioxide emissions footprints for the one or more users when implementing their one or more travel itineraries, the footprint being at least partially determined by a mode of transport employed by the one or more users.

19. The method as claimed in claim 11, wherein the method includes operating the computing hardware to generate one or more alerts when the deviation of the one or more travel itineraries exceeds one or more alarm thresholds.

20. A software product recorded on non-transitory machine-readable data storage media, characterized in that the software product is executable upon computing hardware for executing the method as claimed in claim 11.
